(19) United States
(12) Patent Application Publication
(10) Pub. No.: US 2009/0267763 A1
(43) Pub. Date: Oct. 29, 2009

(54) Information Processing Apparatus, Information Processing Method and Program

(76) Inventor: Keisuke YAMAOKA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/428,082

(22) Filed: Apr. 22, 2009

(30) Foreign Application Priority Data
Apr. 25, 2008 (JP) P2008-115520

(51) Int. Cl. G08B 21/00; H04N 7/18

(52) U.S. Cl. 340/540; 348/135

(57) ABSTRACT

An information processing apparatus includes a user information detection means for detecting user information concerning a user, a score calculation means for calculating a score indicating the degree that a designated object which is an object designated by the user exists at each of plural setting areas which are previously set in a given space based on the user information and a display control means for displaying an image corresponding to scores of the designated object calculated at each of the plural setting areas.

### BACKGROUND OF THE INVENTION

1. Field of the Invention

The present invention relates to an information processing apparatus, an information processing method and a program, and particularly relates to, for example, an information processing apparatus, an information processing method and a program, in which an object lost in a residence can be found easily.

2. Description of the Related Art

In an ordinary house as a residence, various electronic devices represented by a television receiver are provided. There are remote controllers for operating various electronic devices.

In the residence, the remote controller is often put at an unspecified place (area) disorderly after operated by the user.

Similarly in the residence, various keys, a purse, glasses and the like possessed by the user are also often put at unspecified places disorderly by the user just coming home.

Since these objects such as the remote controller, keys, the purse and glasses are relatively small, it is difficult to find them easily when the user forgets a place where he/she put the object.

As a response for the situation, for example, in JP-A-10-173550 (Patent Document 1), a technique in which, when a signal which is unique to a receiver with a search signal reception display attached to a lost object is transmitted by a search signal transmitter, the receiver with the search signal reception display is lit up, or sounded to express the existence thereof is disclosed.

Also, for example, in JP-A-2004-069331 (Patent Document 2), a technique in which electronic tags are attached to objects, and comings and goings of the objects are managed by a finder installed at an entrance of a room is disclosed.

### SUMMARY OF THE INVENTION

However, in the techniques disclosed in Patent Documents 1, 2, it is necessary to attach the receiver with the search signal reception display or electronic tags are attached to objects.

Therefore, for example, when the object is moved or used, the electronic tag and the like attached to the object hinder the moving or using of the object smoothly, which is extremely troublesome. Additionally, it is necessary to prepare the same number of electronic tags and the like as the number of the existing objects.

In view of the above, it is desirable to find a lost object easily without attaching an electronic tag and the like to an object.

An information processing apparatus or a program according to an embodiment of the invention is the information processing apparatus or the program for allowing a computer to function as the information processing apparatus, which includes a user information detection means for detecting user information concerning a user, a score calculation means for calculating a score indicating the degree that a designated object which is an object designated by the user exists at each of plural setting areas which are previously set in a given space based on the user information and a display control means for displaying an image corresponding to scores of the designated object calculated at each of the plural setting areas.

The user information detection means can detect the number of times the user stopped in each of the plural setting areas in a certain period of time as user information, and the score calculation means can calculate the score corresponding to the number of times the user stopped in each of the plural setting areas.

The score calculation means can further calculate the score corresponding to the designated object at each of the plural setting areas.

The user information detection means detects an operation by the user as user information and the score calculation means further calculates the score corresponding to the operation by the user at each of the plural setting areas.

The user information detection means can detect the user information based on a taken image obtained by an imaging device which images the given space.

An information processing method according to an embodiment of the invention is the information processing method of an information processing apparatus calculating a score indicating the degree that a designated object which is an object designated by the user exists at each of plural setting areas which are previously set in a given space and displaying an image corresponding to the scores, which includes a user information detection means, a score calculation means and a display control means, and the information processing method includes the steps of detecting user information concerning a user by the user information detection means, calculating a score indicating the degree that a designated object which is an object designated by the user at each of plural setting areas which are previously set in a given space based on the user information by the score calculation means and displaying an image corresponding to the scores of the designated object calculated at each of the plural setting areas by the display control means.

According to the embodiments of the invention, user information concerning a user is detected, a score indicating the degree that a designated object which is an object designated by the user exists is calculated at each of plural setting areas which are previously set in a given space based on the user information and an image corresponding to the scores of the designated object calculated at each of the plural setting areas is displayed.

According to the embodiments of the invention, a lost object can be easily found.

### BRIEF DESCRIPTION OF THE DRAWINGS

FIG. 1 is a view showing an example in a residential space including an information processing apparatus to which the invention is applied;

FIG. 2 is a view showing an example of a display screen of a monitor;

FIG. 3 is a block diagram showing a detailed configuration example of the information processing apparatus;

FIG. 4 is a flowchart explaining user information storage processing;

FIG. 5 is a flowchart explaining score display processing; and

FIG. 6 is a block showing a configuration example of a personal computer.

### DESCRIPTION OF THE PREFERRED EMBODIMENTS

Hereinafter, embodiments of the invention will be explained with reference to the drawings.

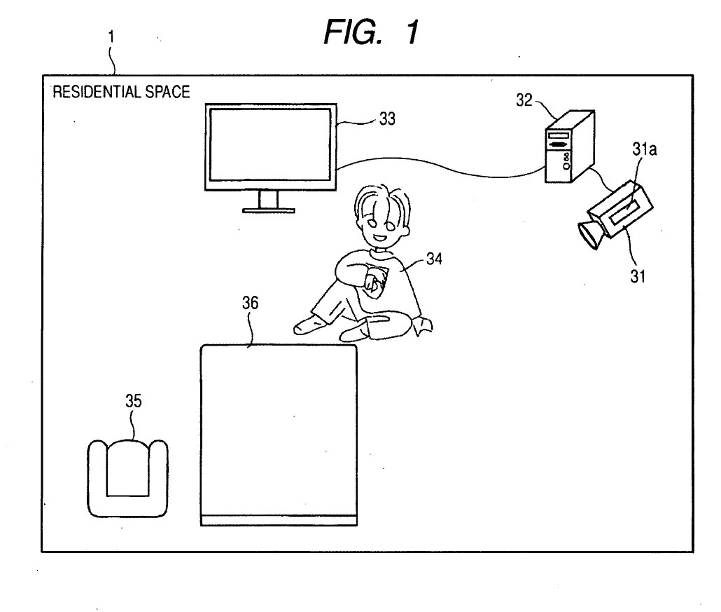

FIG. 1 shows an example of a residential space such as a residence including an information processing apparatus to which the invention is applied.

In a residential space 1, a camera 31 including a laser range finder 31a, an information processing apparatus 32, a monitor 33 such as a television receiver, a chair 35 and a bed 36 possessed by a user 34 living in the residential space 1 are disposed.

The camera 31 is disposed, for example, in the vicinity of a ceiling of the residential space 1. The camera 31 images the residential space 1 from the vicinity of the ceiling and supplies an image in which the user 34 is imaged as a taken image obtained by the imaging to the information processing apparatus 32.

The laser range finder 31a irradiates laser to an imaging target (for example, the user 34) and detects reflected light obtained by the laser irradiated to the imaging target being reflected. Then, time from irradiation of the laser to the imaging target until detection of the reflected light is measured, and imaging target distance indicating the distance from the camera 31 (laser range finder 31a) to the imaging target is calculated based on the measured time and laser speed to supply the distance to the information processing apparatus 32.

The information processing apparatus 32 performs user information storage processing, in which user information concerning the user 34 is detected based on the taken image from the camera 31 and the imaging target distance from the laser range finder 31a and the detected user information is stored. Here, the user information is, for example, a three-dimensional position of the user 34 in the residential space 1.

The information processing apparatus 32 also performs score display processing, in which a total score indicating the degree that an object (designated object) designated by the user 34 exists is calculated at each of plural setting areas which are previously set in the residential space 1 based on user information stored in the user information storage processing and an image corresponding to the calculated total scores is displayed on the monitor 33.

As the setting areas, for example, areas at which the user 34 and like tend to leave the object behind statistically are set by the user 34 and the line. Specifically, for example, areas at which the monitor 33, the chair 35, the bed 36, a table, a chest, a cupboard, a bay window and the like are positioned are set as setting areas.

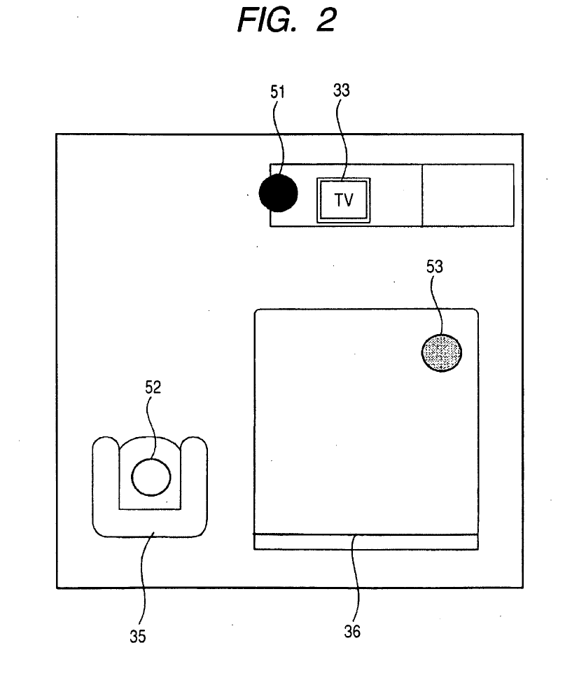

Next, FIG. 2 shows an example of a display screen of the monitor 33.

In the display screen of FIG. 2, the whole image indicating the entire residential space 1 obtained when looking down at the residential space 1 from the above (ceiling).

In the display screen, the monitor 33, the chair 35 and the bed 36 are displayed as well as markers 51 to 53 (shown by circles) indicating total scores calculated at each of plural setting areas at which the monitor 33, the chair 35 and the bed 36 are respectively positioned are displayed.

The markers 51 to 53 are displayed in gray-scales, for example, as the total score of the designated object is larger, the marker is displayed in black and as the total score is lower, the marker is displayed in white.

For example, when the setting area at which the monitor 33 is positioned (setting area of the monitor 33) is the setting area at which the total score of the designated object is the largest in plural setting areas, the black marker 51 indicating that the total score of the designated object is the largest is displayed at the setting area of the monitor 33.

Additionally, for example, the setting area at which the chair 35 is positioned (setting area of the chair 35) is the setting area at which the total score of the designated object is the smallest of plural setting areas, the white marker 52 indicating that the total score of the designated object is the smallest is displayed at the setting area of the chair 35.

Furthermore, for example, the setting area at which the bed 36 is positioned (setting area of the bed 36) is the setting area at which the total score of the designated object is smaller than the setting area of the monitor 33 and larger than the setting area of the chair 35 in plural setting areas, the gray marker 53 indicating that the total score of the designated object is smaller than the setting area of the monitor 33 and the larger than the setting area of the chair 35 is displayed at the setting area of the bed 36.

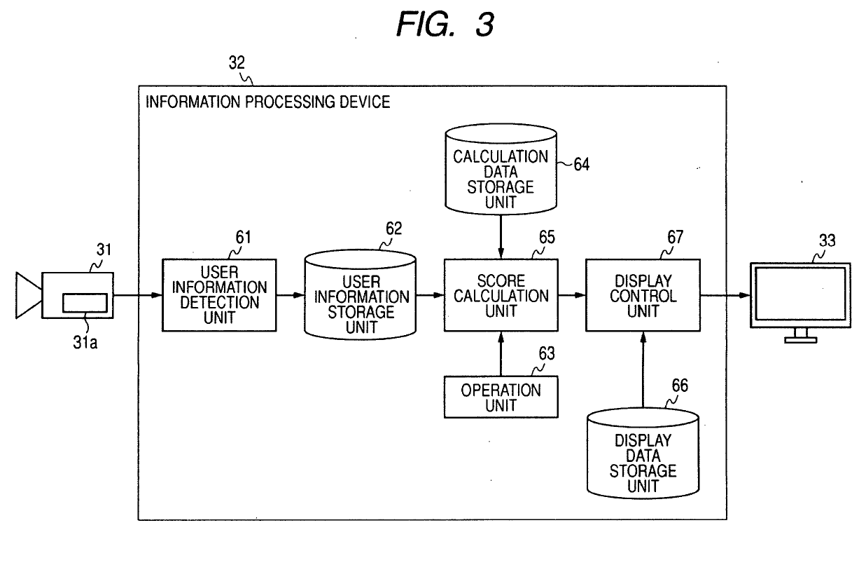

Next, FIG. 3 is a detailed configuration example of the information processing apparatus 32 of FIG. 1.

The information processing apparatus 32 includes a user information detection unit 61, a user information storage unit 62, an operation unit 63, a calculation data storage unit 64, a score calculation unit 65, a display data storage unit 66 and a display control unit 67.

To the user information detection unit 61, a taken image is supplied from the camera 31 as well as an imaging target distance is supplied from the laser range finder 31a.

The user information detection unit 61 detects, for example, a setting area in which the user 34 stopped as user information based on the taken image from the camera 31 and the imaging target distance from the laser range finder 31a.

That is to say, for example, the user information detection unit 61 detects the user 34 in the taken image based on the taken image from the camera 31. Specifically, for example, the user information detection unit 61 detects the user 34 in the taken image by calculating difference between a background image obtained by imaging a background in the residential space 1 (for example, an image of the residential space 1 in which the user 34 does not exist), which has been imaged and stored in advance and a taken image from the camera 31.

In the user information detection unit 61, it is possible to detect the user 34 in the taken image more accurately by applying a method of using Graph Cut and a stereo vision (“Bi-Layer segmentation of binocular stereo video” V. Kolmogorov, A. Blake et al. Microsoft Research Ltd., Cambridge, UK).

The user information detection unit 61 also calculates a three-dimensional position of the user 34 detected from the taken image based on the imaging target distance from the laser range finder 31a.

The three-dimensional position of the user 34 is represented by three-dimensional XYZ coordinates defined by X-axis, Y-axis and Z-axis in which one axis is orthogonal to the other two axes when the position of the laser range finder 31a is the origin (0, 0, 0), which is detected from the direction of laser irradiated to the user 34 and the imaging target distance of the user 34.

Moreover, the user information detection unit 61 stores three-dimensional positions of the monitor 33, the chair 35, the bed 36 and the like which have been calculated in advance by the laser range finder 31a and the like in an internal memory (not shown).

The user information detection unit 61 determines whether the user 34 has stopped in the setting area or not by comparing the calculated three-dimensional position of the user 34 with three-dimensional positions of the monitor 33, the chair 35, the bed 36 and the like stored in the internal memory. Then, only when it is determined that the user 34 has stopped in the setting area, the setting area in which the user 34 has stopped is supplied to the user information storage unit 62 as user information to be stored therein.

The user information storage unit 62 stores user information from the user information detection unit 61.

The operation unit 63 includes designation buttons and the like, which are used by the user 34 for a designating operation for designating a lost object. The operation unit 63, for example, supplies an object signal indicating the object designated by the user 34 to the score calculation unit 65 in response to the designating operation by the user 34.

The calculation data storage unit 64 stores, for example, a position score, a relevance score as calculation data for calculating the total score of the designated object designated by the designating operation of the user 34 by each of the plural setting areas which have been previously set.

Here, the position score indicates a value which is added anew to the total score of the designated object in a certain setting area when the user 34 stops in the certain setting area regardless of the designated object. The relevance score indicates a value which is added anew to the total score of the designated object in the setting area relevant to the designated object when the user 34 stops in the setting area relevant to the designated object.

The setting area relevant to the designated object indicates the setting area in which the designated object is often lost statistically.

The score calculation unit 65 calculates the total score of the designated object at each of plural setting areas based on user information stored in the user information storage unit 62 and calculation data stored in the calculation data storage unit 64 in response to the supply of the object signal indicating the designated object from the operation unit 63.

That is, for example, the score calculation unit 65 calculates the total score of the designated object at each of plural setting areas by using the following formulas (1), (2).

Pₜ(n,f)=Pₜ₋₁(n,f)+hₜ(f){C+A(n,f)} (1)

In the above formula, “n” represents the designated object and “f” represents the setting area. “Pₜ(n,f)” represents the total score of the designated object “n” when the number of times the user 34 has stopped in the setting area “f” in a certain period of time is “t” (times). Assume that an initial value P₀(n,f) is “0”.

Further, “C” represents the position score which is a constant and “A(n,f)” represents the relevance score. The relevance score “A(n,f)” will be, for example, a value “C” when the setting area “f” is the setting area relevant to the designated object “n”, and will be a value “0” when it is not the relevant area.

$${h}_{t} ( f ) = \{ \begin{matrix}1 \text{:} & if ( close to f ) \\ 0 \text{:} & else\end{matrix} \} \qquad ( 2 )$$

In the above formula, “hₜ(f)” will be a value “1” when the user 34 has stopped in the setting area “f”, and will be a value “0” when the user 34 has not stopped in the setting area “f”.

Here, for example, when a purse is designated as a designated object by the designating operation of the user 34, a total score calculation method for calculating the total score of the purse will be explained, which is performed by the score calculation unit 65 when the number of times the user 34 stopped in the setting area of the monitor 33 is twice, the number of times the user 34 stopped in the setting area of the chair 35 is once as well as the number of times the user 34 stopped in the setting area of the bed 36 is twice during a certain period of time (for example, for one hour from the time one hour before the designating operation until the time the designating operation is performed). The setting area of the bed 36 is the setting area relevant to the purse.

The score calculation unit 65 calculates a score P₂(purse, monitor)=P₁(purse, monitor)+h₂(monitor) {C+A(purse, monitor)} when the user 34 stopped in the setting area of the monitor 33 twice during the certain period of time.

Here, P₁(purse, monitor) is P₀(purse, monitor)+h₁(monitor) {C+A(purse, monitor)}, P₀(purse, monitor) is “0”, h₁(monitor) and h₂(monitor) are “1” as well as the setting area of the monitor 33 is the area not relevant to the purse, therefore, A(purse, monitor) will be “0”.

Therefore, the score calculation unit 65 calculates “2 C” as the total score P₂(purse, monitor) of the setting area of the monitor 33.

The score calculation unit 65 calculates a total score P₁(purse, chair)=P₀(purse, chair)+h₁l(chair) {C+A(purse, chair)} when the user 34 stopped in the setting area of the chair 35 once during the certain period of time.

Here, P₀(purse, chair) is “0”, h₁(chair) is “1” as well as the setting area of the chair 35 is the area not relevant to the purse, therefore, A(purse, chair) will be “0”.

Therefore, the score calculation unit 65 calculates “C” as the total score P₁(purse, chair) of the setting area of the chair 35.

Furthermore, the score calculation unit 65 calculates a total score P₂(purse, bed)=P₁(purse, bed)+h₂(bed) {C+A(purse, bed)} when the user 34 stopped in the setting area of the bed 36 twice during the certain period of time.

Here, P₁(purse, bed) is P₀(purse, bed)+h₁(bed) {C+A (purse, bed)}, P₀(purse, bed) is “0”, h₁(bed) and h₂(bed) is “1” as well as the setting area of the bed 36 is the area relevant to the purse, therefore, A(purse, bed) will be C.

Therefore, the score calculation unit 65 calculates “4 C” as the total score P₂(purse, bed) of the setting area of the bed 36.

The score calculation unit 65 supplies the calculated total scores of respective plural setting areas to the display control unit 67.

The display data storage unit 66 stores the whole image indicating the entire residential space 1 which can be obtained when looking down at the residential space 1 from the above and markers (FIG. 2).

The display control unit 67 generates an image of the display screen as shown in FIG. 2 from the whole image and markers stored in the display data storage unit 66 based on the total scores of respective plural setting areas from the score calculation unit 65, supplying the image to the monitor 33 and displaying the image thereon.

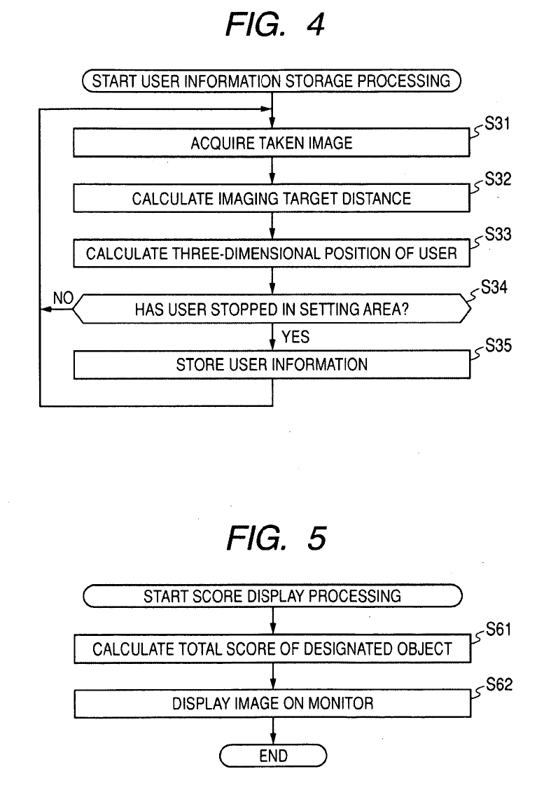

Next, the details of the user information storage processing performed by the information processing apparatus 32 of FIG. 3 will be explained with reference to a flowchart of FIG. 4.

In Step S31, the camera 31 images the residential space 1 from the vicinity of the ceiling and supplies an image in which, for example, the user 34 is imaged to the user information detection unit 61 of the information processing apparatus 32 as a taken image obtained by the imaging.

In Step S32, the laser range finder 31a irradiates laser to the imaging target and detects reflected light obtained by the reflection of the laser irradiated to the imaging target. Then, time from the irradiation of the laser to the imaging target until the detection of reflection light is measured and imaging target distance indicating the distance from the camera 31 (laser range finder 31a) to the imaging target is calculated based on the measured time and laser speed, which is supplied to the user information detection unit 61 of the information processing apparatus 32.

In Step S33, the user information detection unit 61 detects the user 34 in the taken image based on the taken image from the camera 31.

The user information detection unit 61 calculates a three-dimensional position of the user 34 detected from the taken image based on the imaging target distance from the laser range finder 31a.

In Step S34, the user information detection unit 61 determines whether the user 34 has stopped in the setting area or not by comparing the calculated three-dimensional position of the user 34 and the three-dimensional positions such as the monitor 33, the chair 35, the bed 36 and the like stored in the internal memory.

When it is determined that the user 34 has stopped in the setting area in Step S34, the process proceeds to Step S35, and the user information detection unit 61 supplies the setting area in which the user 34 has stopped to the user information storage unit 62 as user information to be stored therein. Then, the process proceeds to Step S31, and the same process will be repeated after that.

On the other hand, when it is determined that the user 34 has not stopped in the setting area in Step 334, the process proceeds to Step S31, and the same process will be repeated after that.

The user information storage processing is ended in response to, for example, an off-operation which is the operation of turning off the power of the information processing apparatus 32 by the user 34.

In the user information storage processing of FIG. 4, user information for calculating the total score of the designated object is detected from the taken image imaged by the camera 31, therefore, it is not necessary, for example, to attach a device for detection or the like used for detecting user information to the object for detecting user information. Additionally, in the user information storage processing, the device for detection or the like is not attached to the object, which allows the user 34 who uses the object to be free of trouble.

Next, the details of score display processing performed by the information processing apparatus 32 of FIG. 3 will be explained with reference to a flowchart of FIG. 5.

The score display processing is started in response to, for example, a designating operation of the operation unit 63 by the laser 34. At this time, the operation unit 63 supplies an object signal indicating the designated object designated by the user 34 to the score calculation unit 65 in response to the designating operation by the user 34.

In Step S61, the score calculation unit 65 calculates the total score of the designated object at each of plural setting areas based on user information stored in the user information storage unit 62 and calculation data stored in the calculation data storage unit 64 in response to the supply of the object signal indicating the designated object from the operation unit 63, supplying the total score to the display control unit 67.

In Step S62, the display control unit 67 generates an image of the display screen as shown in FIG. 2 from the whole image and markers stored in the display data storage unit 66 based on total scores of respective plural setting areas from the score calculation unit 65, supplying the image to the monitor 33 and displaying the image thereon, then, the score display processing is ended.

In the store display processing of FIG. 5, total scores of the designated object at respective plural setting areas are calculated, and markers indicating the total scores of the designated object at respective plural areas are displayed on the monitor 33.

Therefore, the user 34 checks the display screen displayed on the monitor 33 to thereby search for the designated object in the order from the setting area having high probability of arrangement of the designated object, therefore, it is possible to find the designated object more rapidly as compared with the case in which the designated object is searched for depending on memory of the user 34.

In the above embodiment, the constant of the position score is defined as “C”, however, it is not limited to this.

That is, for example, the position score may be changed according to a period of time (for example, “x” (seconds)) when the user 34 stopped in a certain setting area “f”. Specifically, for example, the position score “C” of the formula (1) may be replaced with “xC”.

In this case, the longer the period of time when the user stopped in the certain setting area “f” is, the larger the position score “xC” becomes, therefore, in the case that the longer the period of time when the user stopped in the certain setting area “f”, the higher the probability that the designated object is arranged at the certain setting area “f”, it is possible to calculate more appropriate total score as compared with the total score calculated in the score display processing of FIG. 5, as a result, the designated object can be found more rapidly.

Additionally, in the above embodiment, the constant “C” is added to any area of plural setting areas as the position score, however, it is also possible that, for example, a larger value is added as the position score of the setting area to a setting area in which probability that the user 34 loses the designated object is statistically higher as well as a smaller value is added as the position score of the setting area to a setting area in which probability that the user 34 loses the designated object is statistically lower.

Furthermore, in the above embodiment, the score calculation unit 65 adds the relevance score “A(n, f)” when the user 34 stops the setting area which is relevant to the designated object, in addition to the position score, however, it is not limited to this.

That is, for example, in the information processing apparatus 32, the user information detection unit 61 detects (estimates) the posture of the user 34 as user information, and when the posture of the user 34 detected by the user information detection unit 61 is a given posture, the score calculation unit 65 may add a predetermined posture score corresponding to the given posture.

Specifically, when the designated object “n” is, for example, glasses, and a posture of taking off the glasses by the user 34 has been detected in a certain setting area “f” by the user information detection unit 61, the probability that there exist glasses in the certain setting area “f” is high. Therefore, in this case, it is possible that the score calculation unit 65 calculates a total score Pₜ(glasses, f) of the glasses at this time by adding a posture score corresponding to the posture of taking off the glasses by the user 34 to the total score P_{L-1}(glasses, f) of the glasses at previous time in the certain setting area “f”, in addition to the position score and the relevance score A(n, f).

In this case, the total scores at respective setting areas are calculated in consideration of the posture of the user 34, therefore, it is possible to calculate more appropriate total score as compared with the total score calculated in the score display processing of FIG. 5, which realizes more rapid finding of the designated object.

The user information detection unit 61, for example, generates a silhouette of the user 34 in the taken image from the taken image by the camera 31 and estimates the posture of the user 34 based on the silhouette. A method of estimating the posture of the user from the silhouette is written in, for example, “3D Human Pose from Silhouette by Relevance Vector Regression” A. Agarwal & B. Triggs, INRIA, CVPR'04″

Additionally, in the information processing apparatus 32, for example, it is preferable that the user information detection unit 61 detects an operation (movement) of the user 34 as user information and the score calculation unit 65, when the operation of the user 34 detected by the user information detection unit 61 is a given operation, adds a predetermined operation score corresponding to the given operation.

Specifically, for example, when the designated object “n” is glasses as well as the operation of taking off glasses by the user 34 has been detected in a certain setting area “f” by the user information detection unit 61, the probability that there exist glasses in the certain setting area “f” is high. Therefore, in this case, it is preferable that the score calculation unit 65 calculates the total score Pₜ (glasses, f) of glasses at this time by adding the operation score corresponding to the operation of taking off glasses by the user 34 to the total score Pₜ₋₁(glasses, f) of glasses at previous time in the certain setting area “f”, in addition to the position score and the relevance score A (n, f).

In this case, the total scores at respective setting areas are calculated in consideration of the operation of the user 34, therefore, it is possible to calculate more appropriate total score as compared with the total score calculated in the score display processing of FIG. 5, which realizes more rapid finding of the designated object.

The user information detection unit 61 detects the operation of the user 34 by acquiring plural rectangular modules from the taken image of the camera 31 based on colors or texture, and by capturing the user 34 in the taken image from the acquired plural rectangular modules by using kinematics constraints. A method of detecting the operation of the user is written, for example, in “Findings and Tracking People from the Bottom Up” D. Ramanan & D. A. forsyth, UC Berkely, CVPR'03″. Additionally, the user information detection unit 61 can detect operation of the user 34 without adding any instrument to the user 34, which is used for detecting the operation of the user 34.

In addition to the above-described total-score calculation method which calculates the total score of the designated object, it is possible to perform the total-score calculation method by any combination of the position score, the relevance score, the posture score and the operation score.

In the above embodiment, the user information detection unit 61 detects, for example, the setting area in which the user 34 has stopped as user information based on the taken image from the camera 31, however, it is not limited to this. That is, it is possible to detect the setting area in which the user 34 has stopped by the user information detection unit 61 by arranging, for example, a PIR sensor or the like which detects the user 34 from temperature change in the setting area at each of the plural setting areas set in the residential space 1.

In the above embodiment, the display control unit 67 displays the total scores of the designated object by the markers, however, it is not limited to this. That is, for example, the display control unit 67 may display the total scores of the designated object as numerals or may display the total scores as a bar-graph.

In the above embodiment, the display control unit 67 displays the total scores of the designated object at respective plural setting areas, however, it is not limited to this. That is, for example, the display control unit 67 may display total scores of respective objects in one setting area of plural setting areas.

In the above embodiment, the area in the residential space 1 is set as plural setting areas, however, in addition to this, it is possible to set areas in the residential space 1 and a residential area which is different from the residential space 1 as plural setting areas.

That is, for example, when there exist a given room and another room which is different from the given room in the residence of the user 34, a camera is disposed in the vicinity of the ceiling of the given room as well as a camera is also disposed in the vicinity of the ceiling of another room, thereby setting areas in the given room and another room as plural setting areas.

It is also preferable to set areas in spaces such as in a factory or a company, in which there is the probability that the user loses the object as plural setting areas, in addition to the residential space 1.

In the above embodiment, user information is stored in the user information storage unit 62 in the user information storage processing of FIG. 4, and the total scores of the designated object are calculated and displayed based on user information stored in the user information storage unit 62 in the score display processing of FIG. 5 in response to the designating operation by the user 34, however, it is not limited to this.

That is, for example, it is also preferable that user information is supplied to the score calculation unit 65 through the user information storage unit 62 in the user information storage processing of FIG. 4, and that the total score of the designated object which is previously designated is calculated and displayed every time when user information is supplied in the score display processing of FIG. 5.

In the above embodiment, the imaging target distance indicating the distance from the camera 31 to the imaging target is calculated by the laser range finder 31a, however, in addition to that, it is possible to provide the camera 31 and another camera which is different from the camera 31 to calculate the imaging target distance by stereo processing which calculates the imaging target distance by parallax between the camera 31 and another camera.

As the information processing apparatus according to an embodiment of the invention, for example, a personal computer and the like can be applied.

The above series of processing can be executed by dedicated hardware as well as can be executed by software. When the series of processing is executed by software, programs included in the software are installed from a recording medium to a so-called embedded computer or, for example, a general-purpose personal computer which can execute various functions by installing various programs.

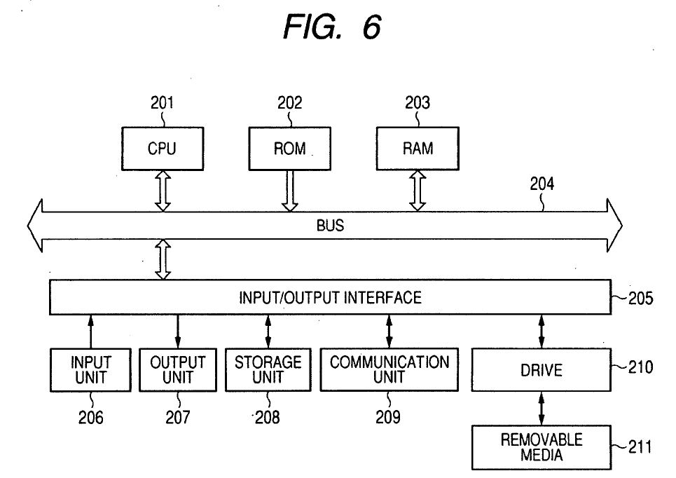

FIG. 6 is a configuration example of a personal computer executing the above series of processing by programs.

A CPU (Central Processing Unit) 201 executes various processing in accordance with programs stored in a ROM (Read Only Memory) 202 or a storage unit 208. In a RAM (Random Access Memory) 203, programs executed by the CPU 201 and data are appropriately stored. The CPU 201, the ROM 202 and the RAM 203 are connected to one another by a bus 204.

An input/output interface 205 is also connected to the CPU 201 through the bus 204. To the input/output interface 205, an input unit 206 including a keyboard, a mouse, a microphone and the like and an output unit 207 including a display, a speaker and the like are connected. The CPU 201 executes various processing in response to instructions inputted from the input unit 206. Then, the CPU 201 outputs results of processing to the output unit 207.

The storage unit 208 connected to the input/output interface 205 includes, for example, a hard disc, storing programs executed by the CFU 201 and various data. A communication unit 209 performs communication with external devices through networks such as Internet or local area networks.

It is also preferable that programs are acquired through the communication unit 209 and stored in the storage unit 208.

A drive 210 connected to the input/output interface 205, when removable media 211 such as a magnetic disc, an optical disc, a magnetic optical disc or a semiconductor memory are mounted, drives them and acquires programs, data and the like stored therein. The acquired programs and data are transferred to the storage unit 208 and stored therein if necessary.

The recording media recording (storing) programs allowed to be installed in the computer and executable by the computer includes removable media 211 which are packaged media such as a magnetic disc (including a flexible disc), an optical disc (including a CD-ROM (Compact Disc-Read Only Memory) and a DVD (Digital Versatile Disc), a magnetic optical disc (including a “MD (Mini-Disc)” (Registered Trademark of Sony Corporation)) or a semiconductor memory, the ROM 202 in which programs are stored temporarily or permanently, the hard disc included the storage unit 208 and the like. The recording of programs to the recording media is performed by using wired or wireless communication media such as local area networks, Internet and digital satellite broadcasting through the communication unit 209 which is an interface such as a router, a modem and the like, if necessary.

In the specification, steps describing programs recorded in the recording media include not only processing performed in time series along the written order but also processing executed in parallel or individually though not always processed in time series.

The embodiment of the invention is not limited to the above embodiment and can be variously modified within the scope not departing from the gist of the invention.

The present application contains subject matter related to that disclosed in Japanese Priority Patent Application JP 2008-115520 filed in the Japan Patent Office on Apr. 25, 2008, the entire contents of which is hereby incorporated by reference.

It should be understood by those skilled in the art that various modifications, combinations, sub-combinations, and alterations may occur depending on design requirements and other factors insofar as they are within the scope of the appended claims or the equivalents thereof.

What is claimed is:

1. An information processing apparatus comprising:
a user information detection means for detecting user information concerning a user;
a score calculation means for calculating a score indicating the degree that a designated object which is an object designated by the user exists at each of plural setting areas which are previously set in a given space based on the user information; and
a display control means for displaying an image corresponding to scores of the designated object calculated at each of the plural setting areas.

2. The information processing apparatus according to claim 1,
wherein the user information detection means detects the number of times the user stopped in each of the plural setting areas in a certain period of time as the user information; and
wherein the score calculation means calculates the score corresponding to the number of times the user stopped in each of the plural setting areas.

3. The information processing apparatus according to claim 2,
wherein the score calculation means further calculates the score corresponding to the designated object at each of the plural setting areas.

4. The information processing apparatus according to claim 2,
wherein the user information detection means detects an operation by the user as user information, and
wherein the score calculation means further calculates the score corresponding to the operation by the user at each of the plural setting areas.

5. The information processing apparatus according to claim 1,
wherein the user information detection means detects the user information based on a taken image obtained by an imaging means which images the given space.

6. An information processing method of an information processing apparatus calculating a score indicating the degree that a designated object which is an object designated by a user exists at each of the plural setting areas which are previously set in a given space and displaying an image corresponding to the scores, which includes
a user information detection means,
a score calculation means, and
a display control means, and
the information processing method comprising the steps of:
detecting user information concerning a user by the user information detection means;
calculating a score indicating the degree that a designated object which is an object designated by the user at each of plural setting areas which are previously set in a given space based on the user information by the score calculation means; and
displaying an image corresponding to the scores of the designated object calculated at each of the plural setting areas by the display control means.

7. A program allowing a computer to function as
a user information detection means for detecting user information concerning a user,
a score calculation means for a score indicating the degree that a designated object which is an object designated by the user exists at each of plural setting areas which are previously set in a given space based on the user information, and
a display control means for displaying an image corresponding to the scores of the designated object calculated at each of the plural setting areas.

8. An information processing apparatus comprising:
a user information detection unit configured to detect user information concerning a user;
a score calculation unit configured to calculate a score indicating the degree that a designated object which is an object designated by the user exists at each of plural setting areas which are previously set in a given space based on the user information; and
a display control unit configured to display an image corresponding to scores of the designated object calculated at each of the plural setting areas.
